(19) United States
(12) Patent Application Publication
(10) Pub. No.: US 2004/0090577 A1
(43) Pub. Date: May 13, 2004

(54) Bandpass filter for a liquid crystal display, liquid crystal display using the bandpass filter and method of manufacturing the bandpass filter

(76) Inventor: Kazutaka Hara, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/390,183

(22) Filed: Mar. 18, 2003

(30) Foreign Application Priority Data
Mar. 20, 2002 (JP) 2002-078278

(51) Int. Cl. G02F 1/1335

(52) U.S. Cl. 349/117

(57) ABSTRACT

In a bandpass filter 10 comprising a bandpass filter layer 2 for selectively allowing light to pass therethrough, the bandpass filter 10 is made by the step of bonding the bandpass filter layer 2 formed on a supporting substrate 1 to an optical device 3 that constitutes a liquid crystal display, the step of separating the supporting substrate 1 from the bandpass filter layer 2, and the step of transferring the bandpass filter layer 2 to the optical device 3.

### FIELD OF THE INVENTION

This invention relates to a bandpass filter for a liquid crystal display (an optical element for selectively allowing light emitted from a backlight, which constitutes a liquid crystal display, to pass therethrough, thereby orienting the light in parallel), and particularly to a bandpass filter that is capable of being designed with a thin profile and expected not to cause deterioration in optical characteristics, reliability or the like.

### BACKGROUND OF THE INVENTION

An EL (Electric Luminescence) backlight, CCFL (Cold Cathode Fluorescent Lamp) backlight, LED (Light Emitting Diode) backlight, or the like used in a liquid crystal display usually has a peak at a certain wavelength.

Accordingly, by arranging on a light emitting side a bandpass filter, which reflects a certain wavelength of light emitted from a backlight in case of oblique incident light while allowing it to pass therethrough in case of perpendicular incident light, the perpendicular incident light is allowed to pass through the bandpass filter, while the oblique incident light does not pass through the bandpass filter but is reflected thereon, thus enabling light to be parallelized.

The bandpass filter is made by vacuum vapor deposition or electron beam (EB) vapor deposition, precise deposition of cholesteric liquid crystal, use of oriented film of a resin material extruded into a multilayer structure, or precise multilayer thin film deposition of resin materials.

Many bandpass filters made by vapor deposition each are made by vapor-depositing a bandpass filter layer on a supporting substrate such as a glass substrate or a thick film. In order to render the supporting substrate tolerable against deformation or destroy due to internal stress of the bandpass filter layer (vapor deposition layer), it is necessary to thicken the supporting substrate to some extent. Because of this, even though the bandpass filter itself is thin about several μm, the overall thickness of the bandpass filter including the supporting substrate increases and therefore the thickness of the bandpass filter is influenced by the thickness of the supporting substrate in an actual state.

Products made by vapor deposition such as the bandpass filter has a non-flexible deposition layer, which causes internal stress therein and therefore is hard to be separated from the supporting substrate. If such separation is forcedly made, a deposition layer is destroyed in many cases.

In a bandpass filter, which is made by extruding a resin material into a multilayer structure with layers having different refractive indexes and then stretching the same, the stretched bandpass filter layer necessarily has a thickness of several tens μm and is hard to be made thinner than this thickness. Because if attempt is made to have a thinner bandpass filter, variation of optical characteristics is easy to be caused by rupture or unevenly applied stretching force during the stretching operation.

While a bandpass filter itself, which is made by precise deposition of cholesteric liquid crystal, has only a thickness of several μm, it is not possible to be made in good quality unless the deposition is made on a supporting substrate having a thickness of several tens μm in order to control precise deposition and liquid crystal orientation. This is because the supporting substrate must be thickened to provide surface smoothness required for precise deposition and liquid crystal orientation, and the supporting substrate of a film having a thickness of several μm does not have a strength tolerable against stress or the like caused during curing of a film made by precise deposition (bandpass filter layer), for which a thickness of about 38-100 μm is required.

Also, a bandpass filter, which is made in multilayer structure by precise thin film deposition resin materials respectively having different refractive indexes, has only a thickness of about several μm but requires a supporting substrate having a thickness of about several tens μm for the same reason as that for the bandpass filter, which is made by precise deposition of the cholesteric liquid crystal.

As described above, a bandpass filter as a means of parallelizing light emitted from a backlight is not substantially different in thickness from another light parallelizing means such as a microprism sheet or light shielding louver each having a thickness of several tens μm.

Accordingly, in light of a recent and very strict demand for the thickness of an optical device for a liquid crystal display, (for a liquid crystal display used such as in a cellular telephone, reduction by every 10 μm is required), there is a problem that a bandpass filter used as the light parallelizing means may not produce a significant advantage for a thin-profile design.

In the bandpass filter, which is made by the precise deposition of cholesteric liquid crystal, or made by the precise multilayer thin film deposition of resin materials in multilayer structure respectively having different refractive indexes, the bandpass filter itself, which performs an optical function, is tolerable even in the environment of high temperature and high humidity for a prolonged period of time, but some kind of the supporting substrate may not be tolerable in such an environment. As a result, there is a problem in many cases that causes deterioration in reliability of the bandpass filter Further, as in a case that the supporting substrate is made of a biaxial oriented PET or the like having a double refraction property, there may be a problem that causes deterioration in optical characteristics due to the supporting substrate itself.

### SUMMARY OF THE INVENTION

The present invention has been conceived in order to solve the above problems associated with the prior arts. Accordingly, it is an object of the present invention to provide a bandpass filter for a liquid crystal display that is capable of being designed with a thin profile and expected not to cause deterioration in optical characteristics, reliability or the like.

In order to achieve the above object, there is provided a bandpass filter for a liquid crystal display, which includes a bandpass filter layer for selectively allowing light to pass therethrough, characterized in that the bandpass filter is made by the step of bonding the bandpass filter layer formed on a supporting substrate to an optical device that constitutes the liquid crystal display, the step of separating the supporting substrate from the bandpass filter layer, and the step of transferring the bandpass filter layer to the optical device.

With the above arrangement, the bandpass filter (which lacks the supporting substrate) is made by bonding the supporting substrate with the bandpass filter layer formed thereon (this arrangement corresponds to a conventional bandpass filter) to the optical device (e.g., a polarizer and phase difference plate) that constitutes a liquid crystal display, and then separating only the supporting substrate and transferring the bandpass filter layer to the optical device. Accordingly, the bandpass filter of the present invention lacks a supporting substrate, which exists in a conventional bandpass filter, and therefore is capable of preventing increase in thickness, and deterioration in optical characteristics and reliability due to the supporting substrate. Further, since the bandpass filter of the present invention necessitates removing the supporting substrate by separation, the thickness of the supporting substrate need not be taken into account, and therefore a thick supporting substrate can be used in consideration of surface smoothness, as well as influences of thermal history at the time of surface treatment, tensile force, vibration and the like. A thick supporting substrate as available can also enhance the handling capability. Moreover, the supporting substrate can be increased in thickness so as not to be below such a thickness as to enable an automatic bonding machine, which is used in bonding the supporting substrate with the bandpass filter layer formed thereon to an optical device, to securely pick up a single piece of film and hence avoid improper operation. As such, it is possible to reduce misoperation in manufacturing liquid crystal displays and hence achieve reduced manufacturing costs because of improved yield rates.

Preferably, the bandpass filter layer is made by precise thin film deposition of cholesteric liquid crystal on a supporting substrate, or by precise thin film deposition of resin materials respectively having different refraction indexes in multilayer structure on a supporting substrate.

A bandpass filter layer, which is made by precise thin film deposition of cholesteric liquid crystal on a supporting substrate, or a bandpass filter layer, which is made by precise thin film deposition of resin materials respectively having different refractive indexes in multilayer structure on a supporting substrate is advantageous in the fact that they are easy to be rendered flexible and easy to be separated from the supporting substrate and then transferred to the optical device.

Preferably, the bandpass filter is made by carrying out the transferring step after the optical device subjected to the bonding step has been bonded to a liquid crystal cell of the liquid crystal device.

With the above arrangement, until the optical device (e.g., a polarizer and phase difference plate) subjected to the bonding step is bonded to the liquid crystal cell of the liquid crystal display, the bandpass filter layer is protected by the supporting substrate. That is, the supporting substrate performs surface protection function for the bandpass filter layer, so that it is advantageous to omit the necessity to bond a surface protection film or the like to the bandpass filter after the bandpass filter layer has been separated from the supporting substrate. Further, given the possibility that some kind of a polarizer, phase difference plate or other optical device has a thinner profile or has inferior mechanical strength than the supporting substrate as a result of the development of a thinning technology of a polarizer, phase difference plate or other optical device, the bandpass filter has an advantage because the handling capability is hard to be influenced by the mechanical strength of the optical device.

Preferably, the supporting substrate is subjected to antistatic treatment.

With the above arrangement, it is possible to prevent the occurrence of static electricity during the separation of the supporting substrate from the bandpass filter layer, and hence suppress the possibility of damaging peripheral electronic materials constituting the liquid crystal display or suppress attachment of dusts thereto. Also, the present invention is useful particularly for the case where IC chips are mounted on a liquid crystal cell of a COG (Chip On Glass) or polysilicon TFT (Thin Film Transistor) display, as well as on a liquid crystal display vulnerable to static electricity such as a TFT liquid crystal display.

Preferably, the antistatic treatment is carried out by forming on the supporting substrate an antistatic layer having a surface resistivity of not more than 10¹² Ω, preferably not more than 10¹⁰ Ω and more preferably not more than 10⁸ Ω.

According to the present invention, there is also provided a liquid crystal display, which includes a liquid crystal cell having an optical device to which any one of the above bandpass filter layers has been transferred, and a backlight provided with a light source having bright-light spectrum so as to emit light towards the liquid crystal cell.

According to the present invention, there is also provided a method of manufacturing a bandpass filter for a liquid crystal display, the bandpass filter including a bandpass filter layer for selectively allowing light to pass therethrough, which includes the step of bonding the bandpass filter layer formed on a supporting substrate to an optical device that constitutes the liquid crystal display, the step of separating the supporting substrate from the bandpass filter layer, and the step of transferring the bandpass filter layer to the optical device.

Preferably, the transferring step is carried out after the optical device subjected to the bonding step has been bonded to a liquid crystal cell of the liquid crystal device.

### BRIEF DESCRIPTION OF THE DRAWINGS

FIG. 1 are explanatory views for explaining a method of manufacturing a bandpass filter according to one embodiment of the present invention.

FIG. 2 illustrates transmission spectral characteristics of a selective-reflection, circularly polarizing film according to one example of the present invention.

### DETAILED DESCRIPTION OF THE PREFERRED EMBODIMENTS

An embodiment of the present invention will be hereinafter described with reference to the drawings attached hereto.

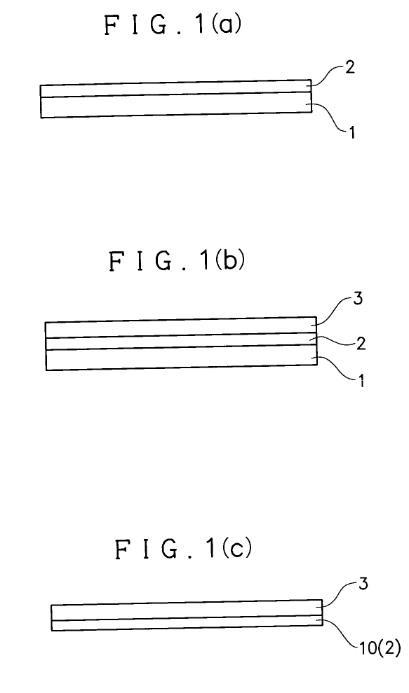

FIG. 1 are explanatory views for explaining a method of manufacturing a bandpass filter according to one embodiment of the present invention. As illustrated in FIG. 1, in order to manufacture a bandpass filter 10 of this embodiment, a bandpass filter layer 2, which is formed on a supporting substrate 1 (FIG. 1(a)) so as to selectively allow light to pass therethrough, is first bonded to an optical device (polarizer, phase difference plate or the like) 3, which constitutes a liquid crystal display (FIG. 1(b)). Then, the supporting substrate 1 is separated from the bandpass filter layer 2, and then the bandpass filter layer 2 is transferred to the optical device 3, thereby making the bandpass filter 10, which is made up of the bandpass filter layer 2 (FIG. 1(c)).

As described above, the bandpass filter 10, which is made up of the bandpass filter layer 2, is made by bonding the supporting substrate 1 with the bandpass filter layer 2 formed thereon to the optical device 3, then separating only the supporting substrate 1, and then transferring the bandpass filter layer 2 to the optical device 3. Accordingly, in the bandpass filter 10 of this embodiment, the supporting substrate 1 does not exist unlike a conventional bandpass filter, and therefore can prevent increase in thickness, deterioration in optical characteristics, reliability and the like due to the presence of the supporting substrate 1. A liquid crystal display may be fabricated by bonding the bandpass filter 10 to a liquid crystal cell (not shown) along with the optical device 3, and then incorporating such as a backlight (not shown) for illuminating the liquid crystal cell.

The bandpass filter layer 2 as illustrated in FIG. 1(a) is made by precise thin film deposition of resin materials respectively having different refractive indexes in multilayer structure on the supporting substrate 1, or by precise thin film deposition of cholesteric liquid crystal on the supporting substrate 1. Specific examples of this will be described below.

(1) Where the bandpass filter layer is made by laminating thin films of resin materials

A halogenated resin composition represented by such as polyethylene naphthalate, polyethylene terephthalate, polycarbonate, vinyl carbazole and brominated acrylate, a high refractive index resin material such as a resin composition with ultrafine particles of a high refractive index inorganic material embedded therein, a fluorocarbon resin material represented by such as trifluoroethyl acrylate, and a low refractive index resin material such as an acrylic resin represented by polymethyl methacrylate. These materials having respectively different refractive indexes are laminated on the supporting substrate 1 so that the bandpass filter layer 2 can be made.

(2) Where the bandpass filter layer is made by using cholesteric liquid crystal A thin film of cholesteric spiral pattern for enabling selective light reflection is formed on the supporting substrate 1 by lyotropic liquid crystal or thermotropic liquid crystal. The thin film is subjected to UV polymerization, drying, heat-curing or the like so as to have a fixed structure so that the bandpass filter layer 2 can be made.

While the supporting substrate 1 may be made by various materials, as far as they enable precise and accurate film formation of the bandpass filter layer 2, a resin film is commonly used for it. As an example of the resin film, it can be cited a film made of a cellulosic polymer such as cellulose diacetate and cellulose triacetate, polyester polymer such as polyethylene terephthalate and polyethylene naphthalate, polymer such as polyolefin polymer and polycarbonate polymer, or the like is preferably used since it provides excellent surface smoothness and has less deficiencies.

Since the supporting substrate 1 is finally removed and therefore does not have an upper limitation of thickness, so that a thicker supporting substrate 1 can be intentionally used according to the size thereof in order to enhance handling capability.

For example, the supporting substrate 1 having a diagonal length of about 10 inches can easily be handled even if it has a thickness of not more than 200 μm. However, where the supporting substrate 1 has a diagonal length of about 40 inches, the supporting substrate 1 having a thickness of about 200 μm is hard to be handled since it is greatly bent due to its own weight. Accordingly, if the thickness of the supporting substrate 1 is increased by such as about 1 mm, it can perform its function as a supporting substrate until the end of the handling operation, and therefore produce an excellent advantage in handling capability (productivity), while causing no undesirable influence on a thin-profile design of a liquid crystal display since the supporting substrate 1 is removed by separation after it has been bonded to the optical device 3.

The supporting substrate 1 is preferably subjected to antistatic treatment in order to prevent occurrence of static electricity at the time of separation of the supporting substrate 1 from the bandpass filter layer 2, thereby suppressing the possibility of damaging peripheral electronic materials, which constitute the liquid crystal display, or attachment of dusts. This antistatic treatment technique is not necessarily limited to a specific one, but preferably involves forming a film, which has been subjected to permanent antistatic treatment, as an antistatic layer. This permanently antistatic film is properly formed on the supporting substrate by depositing on the supporting substrate 1 a resin film with such as conductive fine particles embedded therein.

The optical device 3 is a polarizer or a phase difference plate. Although the material, type or the like of the optical device 3 is not necessarily limited to a specific one, an oriented film of polycarbonate, a product with an oriented liquid crystal polymer deposited thereon, or the like is preferably used, where a phase difference plate is used as the optical device 3. A surface of the optical device 3 is preferably subjected to saponification or corona treatment so as to facilitate bonding.

As adhesive for bonding the bandpass filter layer 2 to the optical device 3, acrylic adhesive or epoxy adhesive, which has excellent transparency and reliability, is preferably used, although various materials can be used. Adhesive is preferably applied in a thin layer, and applied with a thickness of usually not more than 25 μm, preferably not more than 10 μm, and more preferably not more than 5 μm but not less than 0.5 μm.

Now, the description will be made in detail for the setting procedure for setting a selective wavelength allowed through the bandpass filter 10.

The bandpass filter 10 of this embodiment is set to exhibit a maximum transmittance (a wavelength exhibiting a maximum transmittance will be referred to a maximum transmission wavelength) at a wavelength corresponding to a peak wavelength in the emission spectrum of a backlight (not shown) that constitutes the liquid crystal display, while having a reflection wavelength with a 50% or more cut rate (a wavelength having a reflectance of not less than 50%) on the longer wavelength side than the maximum transmission wavelength.

As will be described later, the parallelism of light passing through the bandpass filter 10 is varied according to the difference between the reflection wavelength and the maximum transmission wavelength, so that this difference can be arbitrarily set based upon each purpose.

That is, the reflection wavelength with a 50% or more cut rate according to the incident angle θ of light into the bandpass filter 10 is approximately derived from the following equation (1):

λ2=λ1×(1−(n0/ne)²×sin²θ)^{1/2} (1)

wherein λ1 represents a value of the reflection wavelength, which reflects 50% or more of perpendicular incident light, λ2 represents a value of the reflection wavelength, which reflects 50% or more of light with θ incident angle, n0 represents a refractive index of an external medium (1.0 for the air interface), ne represents an effective refractive index of the bandpass filter 10 and θ represents an incident angle.

According to the above equation (1), for example, where the reflection wavelength λ1=555 nm and the effective refractive index of the bandpass filter 10 ne=2.0 for a peak wavelength of 545 nm in the emission spectrum of the backlight, while they are arranged with leaving air interfaces, the incident angle θ, which enables the reflection wavelength λ2=545 nm, is about ±22 degrees. That is, as far as the incident angle θ is within an angular range of about ±22 degrees, it is possible to obtain a transmittance of 50% or more. Contrarily, as far as the incident angle θ is out of the angular range of about ±22 degrees, λ2 is smaller than 545 nm (λ2<545 nm). As a result, light of the backlight having a peak wavelength of 545 nm, which is on the longer wavelength side than the aforesaid λ2, 50% or more does not pass through the bandpass filter 10. Likewise, when the reflection wavelength λ1=547 nm, the incident angle θ, which enables the reflection wavelength λ2=545 nm, is about ±10 degrees, while the incident angle θ, which enables the reflection wavelength λ2=545 nm, is about ±5 degrees when the reflection wavelength λ1=545.5 nm.

Thus, it is possible to freely control the parallelism of light passing through the bandpass filter 10 by setting the maximum transmission wavelength of the bandpass filter 10 (peak wavelength in the emission spectrum of the backlight) and the reflection wavelength λ1.

Where plural peak wavelengths exist in the emission spectrum of the backlight, the same setting procedure can be applied to each wavelength. For example, where a light source of the backlight is a three-band cold cathode lamp, peak wavelength is frequently set at 435 nm for blue light, 545 nm for green light and 610 nm for red light. Accordingly, the reflection wavelength λ1 of the bandpass filter 10 can be set for each peak wavelength.

While the maximum transmittance of each wavelength in the bandpass filter 10 may be varied according to the designed film quality, it is possible to allow the backlight to have an emission spectrum intensity matched to the maximum transmittance of each wavelength by adjusting the amount of a fluorescent material in each color of the light source, which makes up the backlight, making the backlight match to the maximum transmittance at each wavelength, or adjusting the power supply to each light emitting diode of the light source (made up of plural light emitting diodes), which constitutes the backlight, thus adjusting the hue of passing light.

As disclosed in Japanese Patent Application Nos. 2001-60005 and 2000-281382, with respect to the angular characteristics of selective reflections of cholesteric liquid crystal where the bandpass filter 10 is made by using a cholesteric liquid crystal material, the wavelength range of selectively reflected light Δλ is derived, based upon the difference in average refractive index of cholesteric liquid crystal, from the following equation (3):

Δλ=Δn×P×cos θ (3)

wherein P represents a pitch interval of the spiral pattern of cholesteric liquid crystal, and θ represents an incident angle.

According to the above equation (3), it is possible to design and control the parallelism of the passing light in the same manner as in the case of the bandpass filter.

While the description of this embodiment was made by taking for example the case where the bandpass filter 10 is made by separating the supporting substrate 1 from the bandpass filter layer 2 immediately after the bandpass filter 2 formed on the supporting substrate 1 has been bonded to the optical device 3, the bandpass filter of the present invention is not limited to this arrangement. For example, it is possible to make the bandpass filter by bonding the bandpass filter layer 2 to the optical device 3, then boding this optical device 3 to a liquid crystal cell, which constitutes the liquid crystal display, and then separating the supporting substrate 1 from the bandpass filter layer 2.

According to the above arrangement, the bandpass filter layer 2 is protected by the supporting substrate 1 until the optical device 3, which has been subjected to the bonding process, is bonded to the liquid crystal cell. That is, the supporting substrate 1 performs surface protection function for the bandpass filter layer 2. This is advantageous since it is not necessary to bond a surface protection film or the like to the bandpass filter layer 2 after the supporting substrate 1 is separated from the bandpass filter 2. Given the possibility that some kind of a polarizer, phase difference plate or other optical device has a thinner profile or has inferior mechanical strength than the supporting substrate 1 as a result of the development of a thinner technology of a polarizer, phase difference plate or other optical device, the bandpass filter has an advantage because the handling capability is hard to be influenced by the mechanical strength of the optical device.

The characteristics of the present invention will be more clearly demonstrated by presenting examples as follows.

### EXAMPLE 1

A selective-reflection, circular polarizing film was prepared by thin film deposition of cholesteric liquid crystal polymer, which film reflects right-circular polarized light in selective reflection wavelength ranges of 440 nm to 490 nm, 550 nm to 600 nm and 615 nm to 700 nm, respectively for emission wavelengths of 435 nm, 545 nm and 610 nm of the spectrum of a three-band cold cathode lamp. Three types of polymer liquid crystal mixtures were prepared with reference to the disclosure of European Patent Application Publication No. 834754 so as to respectively have selective reflection center wavelengths of 480 nm (blue), 560 nm (green) and 655 nm (red). Specifically, a nematic monomer A having the following formula (1) and a chiral monomer B having the following chemical formula (2) (which monomer is formed symmetrically in mirror image fashion relative to a corresponding one described in European Patent Application Publication No. 834754) were respectively synthesized.

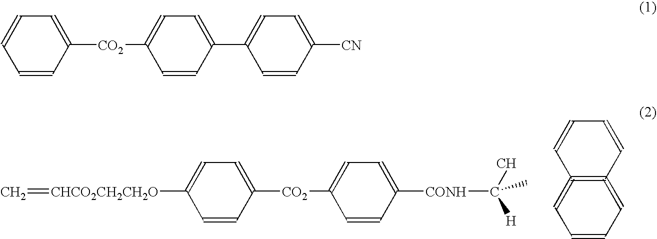

Then, the liquid crystal compositions A and B were mixed at the following ratios according to each selective reflection center wavelength. Specifically, the mixing was made at the ratio of composition A/composition B=9.81 for a selective reflection center wavelength of 480 nm, 11.9 for a selective reflection center wavelength of 560 nm, and 14.8 for a selective reflection center wavelength of 655 nm.

Each of the above mixtures was used to prepare a 33 wt. % tetrahydrofran solution, which was nitrogen purged in an environment at a temperature of 60° C., added a 0.5 wt. % reaction initiator (azobisisobutyronitrile), and subjected to a polymerization treatment. The resulting polymerized materials were reprecipitated, separated and purified by diethyl ether.

As supporting substrates to which the polymerized materials are deposited, a PET film having a thickness of 75 μm was used. A PVA layer having a thickness of about 0.1 μm was deposited on the surface of each supporting substrate, which was in turn rubbed with rubbing cloth of rayon.

Each of the polymerized materials was used to prepare a 10 wt. % methylene chloride solution, which was in turn deposited on each of the supporting substrates with a wire bar so as to have a dry thickness of about 1 μm. After the deposition, they were dried at 140° C. for 15 minutes. After this drying treatment was completed, liquid crystal was cooled and solidified. Thus, a liquid crystal film was produced.

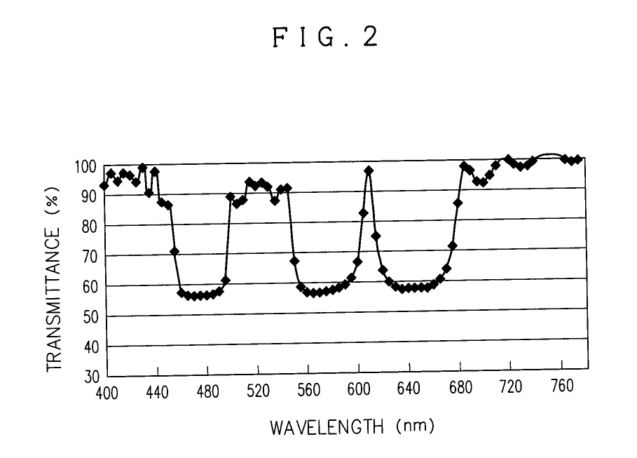

The polymerized materials, which were respectively polymerized at the above ratios, were thus subjected to the above processes so as to prepare liquid crystal thin films of RGB colors respectively corresponding to the selective reflection center wavelengths. The liquid crystal thin films were then bonded to each other with AD244, transparent isocyanate adhesive (manufactured by Tokushu Shikiryo Kogyo K.K.). More specifically, the surface of liquid crystal of red is bonded to the surface of liquid crystal of green, and then a PET film of the green side was then separated. Then, the surface of liquid crystal of blue and the surface of liquid crystal of green was bonded together, and then a PET film of the red side was separated in the same manner as above. These three liquid crystal layers were laminated to each other so as to be aligned in sequence from the short-wavelength side. Whereby, a selective-reflection, circularly polarizing film, which has a complex layer structure of liquid crystal having a thickness of about 5 μm (a supporting substrate is made up of a PET film to which a blue liquid crystal thin film has been deposited), was prepared. Transmission spectral characteristics of the thus prepared selective-reflection, circularly polarizing film are illustrated in FIG. 2.

On the other hand, along with the selective-reflection, circularly polarizing film, a polarizer with a NIPOCS film manufactured by Nitto Denko Ltd. having a function of reflecting left-circular polarized light (NIPOCS film: PCF400, Polarizer:TEG1465DU) was used, in which the surface of the polarizer on the side of NIPOCS and the surface of liquid crystal of the selective-reflection, circularly polarizing film were subjected to corona treatment and bonded together with AD244, transparent isocyanate adhesive (manufactured by Tokushu Shikiryo Kogyo K.K.).

A multilayer film thus produced was die-cut by Thomson blade die into a size and angular shape (a polarizer angle of 45 degrees, a diagonal length of 293 mm) matched to an 11 inch TFT liquid crystal display. The multilayer film thus die-cut was bonded to the liquid crystal cell and subjected to autoclave treatment (at a pressure of 5 atm and a temperature of 70° C. for 30 min). Then, an adhesive tape was bonded to an edge of the multilayer film, and then peeled away therefrom so as to remove a PET film left on the surface of the multilayer film.

Thus, a bandpass filter made up of the selective-reflection, circularly polarizing film having complex layer structure of liquid crystal and the NIPOCS film was produced. According to the bandpass filter of this embodiment, the PET film performs surface protection function, which produces an advantage that the necessity of bonding a surface protection film can be omitted. The multilayer film bonded to the liquid crystal cell has a thickness of about 310 μm (including the thickness of the polarizer), and thus reduced the thickness by an amount corresponding to the thickness of the PET supporting substrate (75 μm).

### EXAMPLE 2

A bandpass filter layer was prepared by multilayer thin-film deposition of resin materials respectively having different refractive indexes. Specifically, fluorinated acrylate resin (LR202B manufactured by Nissan Chemical Industries, Ltd.) was used as a low refraction resin material, and acrylate resin with ultrafine particles of a high refractive index inorganic material embedded therein (DeSolite manufactured by JSR Corporation) was used as a high refractive index resin material. Twenty-one layers of them were laminated on a supporting substrate (PET film manufactured by Teijin Ltd. having a thickness of about 80 μm) by multilayer thin film deposition. The PET film of the supporting substrate was not subjected to the treatment for facilitating bonding, in consideration of the later removal of the PET film.

The fluorinated acrylate resin had a refractive index of about 1.40, and the acrylate resin with ultrafine particles of a high refractive index inorganic material embedded therein had a refractive index of about 1.71. The multilayer thin film deposition was conducted by using a micro gravure coater by repeating the steps of drying each laminated film at 90° C. for 1 min, curing it by ultraviolet polymerization (at an illumination intensity of 50 mW/cm² for 1 see), and depositing another film on the cured film. The thus prepared bandpass filter layer exhibited insufficient homogeneity in in-plane transmission spectrum characteristics and therefore a region thereof, which had proper characteristics for an applicable wavelength range, was selected for use.

Thus, the bandpass filter layer, which has selective reflection wavelength ranges of 420 nm to 450 nm, 530 nm to 550 nm, and 600 nm to 620 nm, respectively for emission wavelengths of 435 nm, 545 nm and 610 nm of the spectrum of the three-band cold cathode lamp, was prepared. The total deposition thickness was slightly less than 4 μm.

The thus produced optical film (the bandpass filter layer plus the PET film) was bonded to an original plate of a polarizer, which polarizer being to be mounted to the liquid crystal cell on its backlight side, with an optical adhesive layer having a thickness of 2 μm (Optcrape manufactured by K.K. Ardel). This was die-cut into a size matched to the liquid crystal display and then bonded to the liquid crystal cell. Then, the PET film as the supporting substrate was removed by separation so as to form a bandpass filter.

It has been found that the above three wavelengths of light passing through the bandpass filter of this embodiment each are parallelized within an angular range of about ±20 degrees relative to the front. As a result of the addition of the bandpass filter, the thickness was increased about 6 μm so that the removal of the supporting substrate resulted in decrease in thickness by about 80 μm.

### EXAMPLE 3

A bandpass filter layer was made by thin-film deposition of cholesteric liquid crystal polymer on a supporting substrate of a polyethylene terephthalate film having a thickness of 80 μm so as to produce a film 1 and a film 2.

More specifically, a selective-reflection, circular polarizing film, which reflects right-circular polarized light in selective reflection wavelength ranges of 440 nm to 490 nm, 550 nm to 600 nm and 615 nm to 700 nm, respectively for emission wavelengths of 435 nm, 545 nm and 610 nm of the spectrum of a three-band cold cathode lamp, was prepared. The deposition thickness of the film 1, that is, the thickness of the bandpass filter layer was slightly less than 5 μm.

Cholesteric liquid crystal polymer was used and three layers respectively having different selective-reflection center wavelengths were redeposited and subjected to Grandjean orientation so that the film 2, which reflects left-circular polarized light in the entire wavelength range of visible light between 410 nm and 700 nm, was prepared. This is a reflective circular polarizer, which is usually used for the purpose of improving luminance. The deposition thickness of the film 2, that is, the thickness of the bandpass filter layer was slightly less than 5 μm.

The thus produced films 1 and 2 each were cut into a size and angular shape matched to a predetermined liquid crystal display.

A polarizer as used, which is located on the backlight side of the liquid crystal cell and to which the films 1, 2 are bonded (this polarizer corresponds to the optical device of the present invention), had a quarter wavelength plate of liquid crystal polymer formed thereon. The quarter wavelength plate of liquid crystal polymer had a thickness of 3 μm, and a bonding layer between the polarizer and the quarter wavelength plate had a thickness of 3 μm. The bandpass filter was made by bonding the film 1 to the polarizer via adhesive having a thickness of 2 μm, then removing the supporting substrate of the film 1 by separation, then superimposing the film 2 on the polarizer and bonding the same thereto in the same manner, and then removing the supporting substrate of the film 2 by separation.

It has been found that the above three wavelengths of light passing through the bandpass filter of this embodiment each are parallelized within an angular range of about ±15 degrees relative to the front. As a result of the addition of the bandpass filter, the thickness was increased about 20 μm, which greatly contributed to the low-profile design of the liquid crystal display.

### EXAMPLE 4

Since it was hard to handle a 20 inch (diagonal length) class multilayer film formed according to the Example 1, which size corresponding to a large liquid crystal panel size, the PET film was prepared to have a thickness of 175 μm and this thickness was maintained until it has been bonded to the liquid crystal cell. The overall thickness of the multilayer film with including an adhesive-side removable film (this comprises a PET film having a thickness of 38 μm and subjected on a side, which contacts adhesive for bonding the liquid crystal cell, to silicone treatment), was about 540 μm, and it has been found that with this thickness, the multilayer film is hard to be bent or undulated due to its own weight, and therefore easy to be handled.

In this example, the PET film as the supporting substrate was provided on the rear side with an antistatic layer. Specifically, HP4, a material for antistatic treatment (a sol-gel reactive material with conductive ultrafine particles contained therein) manufactured by Sumitomo Osaka Cement Co., Ltd. was used to have an antistatic layer having a thickness of 0.2 μm and a surface resistivity of 5×10⁹ Ω. This antistatic layer caused a static charge of not more than 1000V at the time of separation of the supporting substrate. Thus, it has been found that the antistatic layer is effective for safety purposes, as well as effective in preventing dust attachment, and preventing damages to the liquid crystal cell and IC chips or other peripheral devices.

### COMPARATIVE EXAMPLE 1

A bandpass filter layer was made by thin-film deposition of cholesteric liquid crystal polymer on a supporting substrate, which is made of a cellulose triacetate film having a thickness of 80 μm, so as to produce a film 1 and a film 2.

More specifically, a selective-reflection, circular polarizing film 1, which reflects right-circular polarized light in selective reflection wavelength ranges of 440 nm to 490 nm, 540 nm to 600 nm and 615 nm to 700 nm, respectively for emission wavelengths of 435 nm, 545 nm and 610 nm of the spectrum of a three-band cold cathode lamp, was prepared. The deposition thickness of the film 1, that is, the thickness of the bandpass filter layer was slightly less than 5 μm.

Cholesteric liquid crystal polymer was used and three layers respectively having different selective-reflection center wavelengths were redeposited and subjected to Grandjean orientation so that the film 2, which reflects left-circular polarized light in the entire wavelength range of visible light between 410 nm and 700 nm, was prepared. This is a reflective circular polarizer, which is usually used for the purpose of improving luminance. The deposition thickness of the film 2, that is, the thickness of the bandpass filter layer was slightly less than 5 μm.

It has been found that the above three wavelengths of light passing through the bandpass filter, which was made by bonding the films 1, 2 together with adhesive having a thickness of 25 μm, each are parallelized within an angular range of about ±15 degrees relative to the front. A quarter wavelength plate having a thickness of 50 μm was bonded to the bandpass filter of this comparative example via adhesive having a thickness of 25 μm. The thus produced optical film for parallelizing light of the backlight has an overall thickness of about 245 μm and therefore was found insufficient for a thin-profile liquid crystal display.

In the above described examples and comparative example, there were used: MCPD 2000, Multichannel Spectrophotometer manufactured by Otsuka Electronics Co., Ltd. for measurement of a reflection wavelength range; M220, spectral ellipsometer manufactured by JASCO Corporation for evaluation of thin film characteristics; U4100, spectrophotometer manufactured by Hitachi, Ltd. for evaluation of spectrum characteristics of transmission reflection; DOT3 manufactured by Murakami Color K.K. for evaluation of characteristics of a polarizer; KOBRA21D, Birefringence Analyzer manufactured by Oji Scientific Instruments for measuring a phase difference value; and Ez Contrast manufactured by ELDIM SA for measurement of viewing angle characteristics (contrast, hue, luminance).

According to the present invention, the bandpass filter, which is made up of the bandpass filter, (i.e., the filter lacking the supporting substrate) is made by bonding the supporting substrate with the bandpass filter layer formed thereon to the optical device (e.g., a polarizer and phase difference plate) that constitutes a liquid crystal display, and then separating only the supporting substrate and transferring the bandpass filter layer to the optical device. Accordingly, the bandpass filter of the present invention lacks a supporting substrate, which exists in a conventional bandpass filter, and therefore is capable of preventing increase in thickness, and deterioration in optical characteristics and reliability due to the supporting substrate. Further, since the bandpass filter of the present invention necessitates the removal of the supporting substrate, the thickness of the supporting substrate need not be taken into account, and therefore a thick supporting substrate can be used in consideration of surface smoothness, as well as influences of thermal history at the time of surface treatment, tensile force, vibration and the like. A thick supporting substrate as available can also enhance the handling capability. Moreover, the supporting substrate can be increased in thickness so as not to be below such a thickness as to enable an automatic bonding machine, which is used in bonding the supporting substrate with the bandpass filter layer formed thereon to an optical device, to securely pick up a single piece of film and hence avoid improper operation. As such, it is possible to produce an excellent effect to reduce misoperation in manufacturing liquid crystal displays and hence achieve reduced manufacturing cost because of improved yield rates.

1. A bandpass filter for a liquid crystal display comprising a bandpass filter layer for selectively allowing light to pass therethrough, characterized in that the bandpass filter is made by the step of bonding the bandpass filter layer formed on a supporting substrate to an optical device that constitutes the liquid crystal display, the step of separating the supporting substrate from the bandpass filter layer, and the step of transferring the bandpass filter layer to the optical device.

2. The bandpass filter for a liquid crystal display according to claim 1, wherein the bandpass filter layer is made by precise thin film deposition of cholesteric liquid crystal on a supporting substrate.

3. The bandpass filter for a liquid crystal display according to claim 1, wherein the bandpass filter layer is made by precise thin film deposition of resin materials respectively having different refraction indexes in multilayer structure on a supporting substrate.

4. The bandpass filter for a liquid crystal display according to any one of claims 1 to 3, wherein the bandpass filter is made by carrying out the transferring step after the optical device subjected to the bonding step has been bonded to a liquid crystal cell of the liquid crystal device.

5. The bandpass filter for a liquid crystal display according to any one of claims 1 to 4, wherein the supporting substrate is subjected to antistatic treatment.

6. The bandpass filter for a liquid crystal display according to claim 5, wherein the antistatic treatment is carried out by forming on the supporting substrate an antistatic layer having a surface resistivity of not more than 10¹² Ω.

7. A liquid crystal display comprising a liquid crystal cell having an optical device to which the bandpass filter layer according to any one of claims 1 to 6 has been transferred, and a backlight provided with a light source having bright-light spectrum so as to emit light towards the liquid crystal cell.

8. A method of manufacturing a bandpass filter for a liquid crystal display, the bandpass filter including a bandpass filter layer for selectively allowing light to pass therethrough, which comprises the step of bonding the bandpass filter layer formed on a supporting substrate to an optical device that constitutes the liquid crystal display, the step of separating the supporting substrate from the bandpass filter layer, and the step of transferring the bandpass filter layer to the optical device.

9. The method of manufacturing a bandpass filter for a liquid crystal display according to claim 8, wherein the transferring step is carried out after the optical device subjected to the bonding step has been bonded to a liquid crystal cell of the liquid crystal device
